(19) United States
(12) Patent Application Publication
(10) Pub. No.: US 2009/0155487 A1
(43) Pub. Date: Jun. 18, 2009

(54) ULTRAVIOLET UV PHOTO PROCESSING OR CURING OF THIN FILMS WITH SURFACE TREATMENT

(75) Inventors: MICHAEL P. BELYANSKY, Bethel, CT (US); OLEG GLUSCHENKOV, Poughkeepsie, NY (US)

Correspondence Address: FREDERICK W. GIBB, III;Gibb Intellectual Property Law Firm, LLC, 2568-A RIVA ROAD, SUITE 304, ANNAPOLIS, MD, 21401, US

(73) Assignee: INTERNATIONAL BUSINESS MACHINES CORPORATION, Armonk, NY (US)

(21) Appl. No.: 11/955,500

(22) Filed: Dec. 13, 2007

(51) Int. Cl. B05D 3/06

(52) U.S. Cl. 427/558; 118/642

(57) ABSTRACT

A method provides an etching ambient environment within an ultraviolet curing chamber and can optionally also generate an electrical discharge in the chamber. The method also irradiates the substrate with ultraviolet radiation. The providing of the etching ambient environment, the generating of the electrical discharge, and the irradiating can be performed simultaneously. Alternatively, the providing of the etching ambient environment and the generating of the electrical discharge can be used as a pre-treatment and performed before the irradiating. The etching ambient environment and the generating of the electrical discharge can be provided in such concentrations that the etching ambient environment removes hydrogen and/or oxygen from the deposited thin film.

### FIELD OF THE INVENTION

The embodiments of the invention generally relate to ultraviolet curing chambers and more particularly to a method and chamber that generate an etching ambient within the curing chamber either before or during the curing process.

### BACKGROUND OF THE INVENTION

Ultraviolet curing of thin films is a known technique to alter the chemical structure of films via a photochemical reaction within a film material. For details regarding ultraviolet curing of films, see U.S. Patent Publication 2006/0251827, the complete disclosure of which is incorporated herein by reference. In one useful example, ultraviolet cure can be employed to mechanically strengthen thin low-k films via removal of certain elements such as hydroxyl groups (OH). In another useful example, ultraviolet curing is employed to increase internal mechanical stress in amorphous silicon nitride-based stressors. In this process, excessive hydrogen present in the film after its deposition is removed from the film at a relatively low temperature (for example, below about 500° C.) by irradiating such film with ultraviolet radiation.

In this process, ultraviolet photons are absorbed by Nitrogen-Hydrogen (N—H) and Silicon-Hydrogen (Si—H) chemical pairs present in the silicon nitride-based film, resulting in the breaking up of hydrogen atoms and freeing up extra Nitrogen and Silicon orbitals. The neighboring orbitals can then react producing a more strained Silicon Nitride (SiN) based structure. Highly-strained stressor films are widely employed to exert local mechanical stress onto various microstructures to alter their electrical and optical properties.

### SUMMARY OF THE INVENTION

Disclosed herein is a method embodiment that positions a substrate that has a deposited thin film within a chamber. The method provides an etching ambient environment within the chamber. The method then irradiates the substrate with ultraviolet radiation.

Also disclosed herein is another method that positions a substrate that has a deposited thin film within a chamber. The method provides an etching ambient environment within the chamber. The method generates an electrical discharge in the chamber. The method then irradiates the substrate with ultraviolet radiation.

Disclosed herein is an apparatus comprising a chamber adapted to accommodate a substrate having a deposited thin film. A dispenser is connected to the chamber. The dispenser is adapted to create, within the chamber, an etching ambient environment. An ultraviolet light source within the chamber is adapted to irradiate the substrate with ultraviolet radiation.

Disclosed herein is an apparatus comprising a chamber adapted to accommodate a substrate having a deposited thin film. A dispenser is connected to the chamber. The dispenser is adapted to create, within the chamber, an etching ambient environment. A generator is connected to the chamber. The generator is adapted to generate an electrical discharge in the chamber. An ultraviolet light source within the chamber is adapted to irradiate the substrate with ultraviolet radiation.

### BRIEF DESCRIPTION OF THE DRAWINGS

These and other aspects of the embodiments of the invention will be better appreciated and understood when considered in conjunction with the following description and the accompanying drawings, in which:

FIG. 1 is a schematic diagram of a chamber according to embodiments herein;

FIG. 2 is a schematic diagram of a chamber according to embodiments herein;

FIG. 3 is a schematic diagram of a chamber according to embodiments herein;

FIG. 4 is a schematic diagram of a chamber according to embodiments herein; and

FIG. 5 is a flow diagram illustrating a method embodiment of the invention.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

The process of ultraviolet (UV) curing can be conducted in a neutral ambient (e.g. noble gases and/or molecular nitrogen) or in vacuum. There are several commercially available ultraviolet curing tools. Some provide an integrated solution where the ultraviolet chamber is integrated with a deposition chamber, others provide stand alone tools. The present disclosure can be used with either type and, therefore, can be used with, for example, Silicon Nitride (SiN) ultraviolet curing processes in a stand alone (de-integrated) chamber using a surface treatment feature.

Most processing films subjected to ultraviolet curing have an extremely thin outer surface layer. Because of the extreme thinness of such an outer surface layer (e.g., thicknesses as small as about 1 nm); it is not expected that this outer surface layer would hinder or promote coupling of ultraviolet radiation (where the wavelength of the ultraviolet radiation in vacuum is usually at least 200 nm). Thus, there is no motivation (within those ordinarily skilled in the art) to alter this extremely thin outer surface layer during the process of ultraviolet curing.

The present embodiments break away from such a line of conventional knowledge and specifically alter this very thin outer surface layer of the thicker film being subjected to ultraviolet curing. More specifically, the embodiments herein create an environment (chemical concentrations and electrical charges) within the curing chamber to create a surface treatment environment (certain reactive ambient) such that the outer surface layer of the film is beneficially altered or preserved to speed up the ultraviolet curing process and/or attain a higher benefit of the curing (make the curing more effective). Thus, the embodiments herein can provide a surface pre-treatment feature where the steps of surface treatment and ultraviolet irradiation are two separate steps performed sequentially or simultaneously.

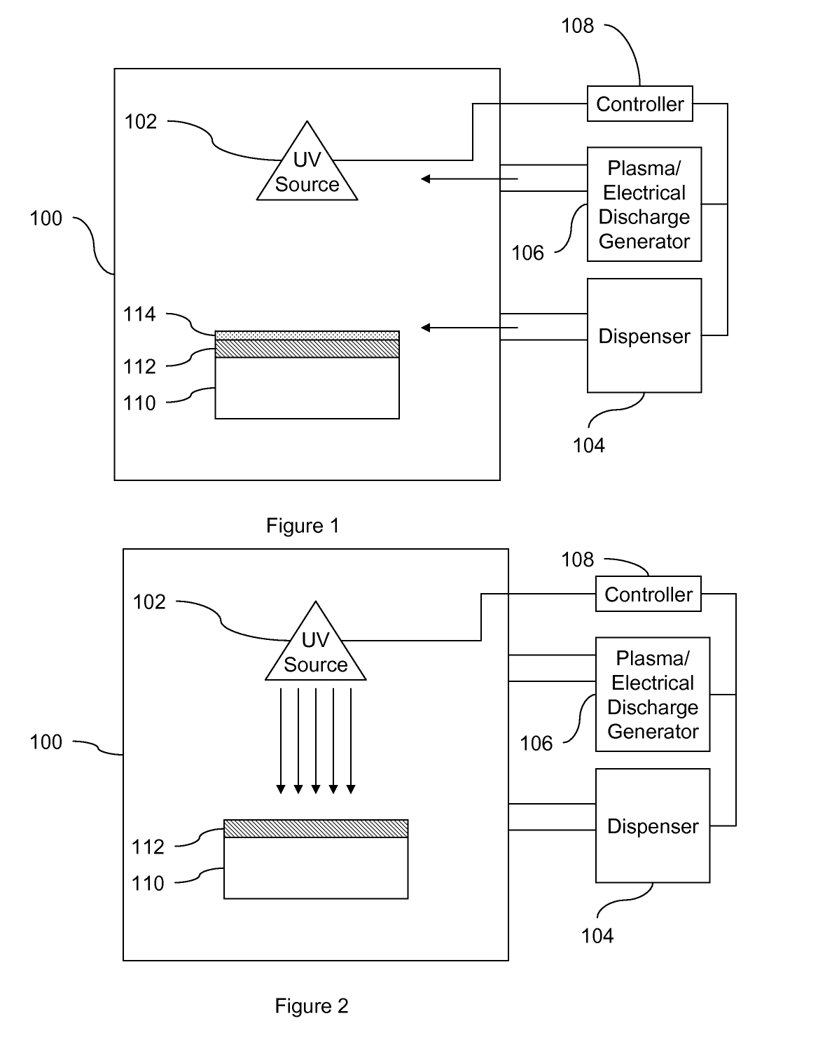

As shown in FIGS. 1-4, various apparatus embodiments are disclosed herein. The embodiments shown in FIG. 1-4, use a chamber 100 adapted to accommodate the substrate 110 that has the deposited thin film 112 to be cured. As mentioned above, the outer surface layer of the thin film 112 is very thin, and the hydrogen and/or oxygen thereon 114 may alter the effectiveness of the curing process.

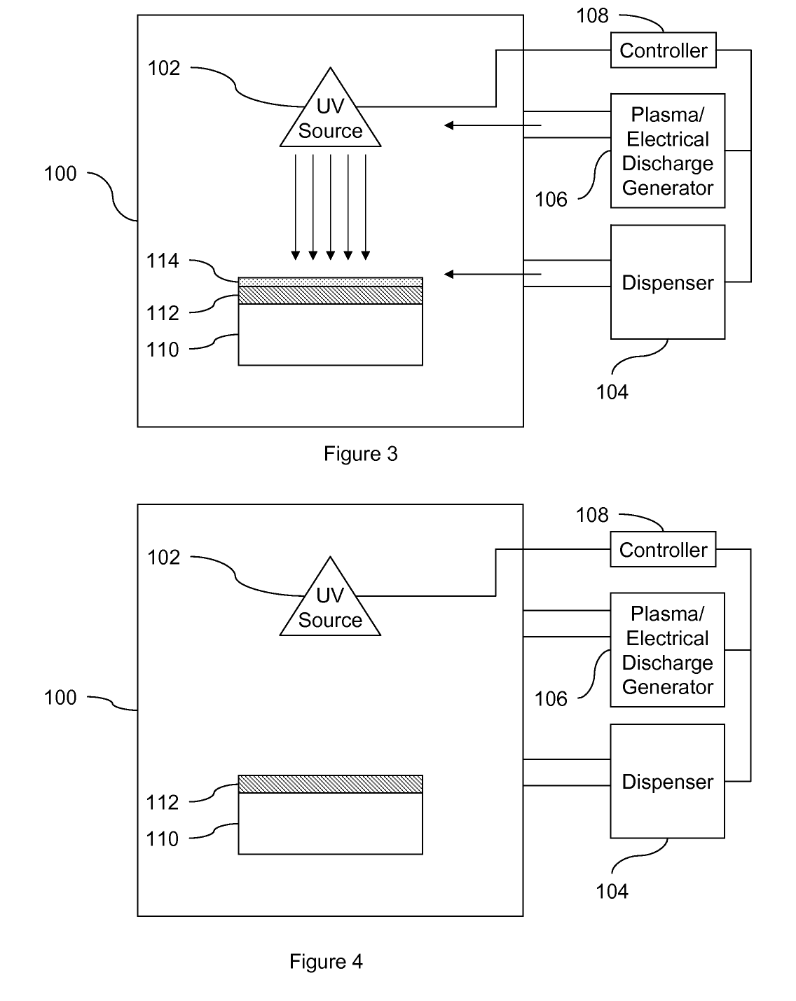

In order to address such issues, these embodiments include a dispenser 104 connected to the chamber 100. The dispenser 104 is adapted to create, within the chamber 100, an etching ambient environment (as indicated by an arrow in FIGS. 1 and 3). In addition, an electrical discharge or plasma generator 106 can optionally be connected to the chamber 100 and be adapted to generate an electrical discharge (as indicated by an arrow in FIGS. 1 and 3) in the chamber 100. An ultraviolet light source 102 within the chamber 100 is adapted to irradiate the substrate with the ultraviolet radiation (as indicated downward by the arrows in FIGS. 2 and 3).

In addition, a controller 108 is connected to the dispenser 104, the generator 106, and the ultraviolet light source. The controller 108 can control these devices (102, 104, 106) to provide the etching ambient environment, the electrical discharge, and the ultraviolet radiation simultaneously. Alternatively, the controller 108 can control the devices (102, 104, 106) to provide the etching ambient environment and the electrical discharge before the ultraviolet radiation. Further, the dispenser 104 is adapted to provide the etching ambient environment in such concentrations, and the generator 106 is adapted to generate the electrical discharge in such a manner that the etching ambient environment removes hydrogen and/or oxygen from the deposited thin film.

Thus, FIG. 1 illustrates an embodiment where the dispenser 104 (and possibly the generator 106) create an environment within the chamber 100 that will remove film 114. After the layer 114 is removed, the ultraviolet curing process occurs as shown in FIG. 2. In this embodiment, removal of film 114 improves the UV curing process by allowing more hydrogen and/or oxygen to escape from film 112. In another embodiment, the etching ambient environment, the optional generating of the electrical discharge, and the irradiating can be performed simultaneously, as shown in FIG. 3. The resulting cured and cleaned thin film 112 is thus produced after all processing is stopped, as shown in FIG. 4. In this embodiment, the reactive chamber ambient aids in removing hydrogen and/or oxygen during the curing process from the outer surface of layer 114, and aids in the removal of layer 114 from layer 112.

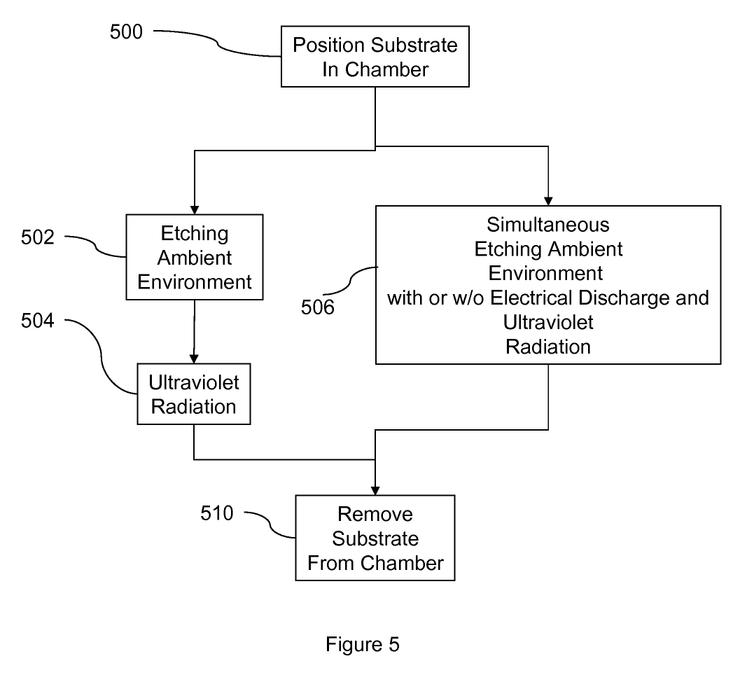

As shown in flowchart form in FIG. 5, a method embodiment herein positions a substrate comprising a deposited thin film to be cured within a curing chamber in item 500. Then, in one embodiment, shown by items 502 and 504, the method sequentially provides the etching ambient environment within the chamber, followed by the irradiation of the ultraviolet radiation. Thus, the providing of the etching ambient environment and the generating of the electrical discharge can be used as a pre-treatment and performed before the irradiating. In a different embodiment, shown in item 506, the method simultaneously provides the etching ambient environment and the irradiation of the ultraviolet radiation in the chamber. Either embodiment can optionally also generate an electrical discharge in the chamber. The etching ambient environment and the generating of the electrical discharge can be provided in such concentrations that the etching ambient environment removes hydrogen and/or oxygen from the deposited thin film. The substrate is then removed from the chamber in item 508.

In one example, the reactive ambient environment created can be designed to be an etchant that can operate at low temperatures (e.g., below about 500° C.) to remove any oxygen and/or hydrogen present on the thin surface layer of the film. One example of the reactive ambient can be halogen-containing volatile species such as F₂, C₁₂, NF₃, HCL, HF, CFx, CLx, and the like. It was discovered that such halogen-containing volatile species are useful at removing hydrogen from the thin outer surface layer of the film at lower temperatures.

Optionally, the reactivity of the halogen-containing ambient can be beneficially increased (especially at lower temperatures) via the use of the in-situ or remote electric discharge or plasma, discussed above. Similarly, if the reactive ambient used is hydrogen that is excited in an electric discharge (e.g., hydrogen plasma), oxygen cleaning at low temperatures is especially effective. Further, with the embodiments herein, the reactivity of the ambient should be selected such that etching of silicon nitride film is minimized. For example, in one area, an allowable amount of Silicon Nitride (SiN) film that is etched during the curing process is limited to not exceed ⅓ of the original thickness.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A method comprising:
positioning a substrate comprising a deposited thin film within a chamber;
providing an etching ambient environment within said chamber; and
irradiating said substrate with ultraviolet radiation.

2. The method according to claim 1, all the limitations of which are incorporated herein by reference, wherein said providing of said etching ambient environment and said irradiating are performed simultaneously.

3. The method according to claim 1, all the limitations of which are incorporated herein by reference, wherein said providing of said etching ambient environment is performed before said irradiating.

4. The method according to claim 1, all the limitations of which are incorporated herein by reference, wherein said etching ambient environment is provided in such concentrations that said etching ambient environment removes hydrogen from said deposited thin film.

5. The method according to claim 1, all the limitations of which are incorporated herein by reference, wherein said etching ambient environment is provided in such concentrations that said etching ambient environment removes oxygen from said deposited thin film.

6. A method comprising:
positioning a substrate comprising a deposited thin film within a chamber;
providing an etching ambient environment within said chamber;
generating an electrical discharge in said chamber; and
irradiating said substrate with ultraviolet radiation.

7. The method according to claim 6, all the limitations of which are incorporated herein by reference, wherein said providing of said etching ambient environment, said generating of said electrical discharge, and said irradiating are performed simultaneously.

8. The method according to claim 6, all the limitations of which are incorporated herein by reference, wherein said providing of said etching ambient environment and said generating of said electrical discharge are performed before said irradiating.

9. The method according to claim 6, all the limitations of which are incorporated herein by reference, wherein said etching ambient environment and said generating of said electrical discharge are provided in such concentrations that said etching ambient environment removes hydrogen from said deposited thin film.

10. The method according to claim 6, all the limitations of which are incorporated herein by reference, wherein said etching ambient environment and said generating of said electrical discharge are provided in such concentrations that said etching ambient environment removes oxygen from said deposited thin film.

11. An apparatus comprising:
a chamber adapted to accommodate a substrate comprising a deposited thin film;
a dispenser connected to said chamber, wherein said dispenser is adapted to create, within said chamber, an etching ambient environment; and
an ultraviolet light source within said chamber adapted to irradiate said substrate with ultraviolet radiation.

12. The apparatus according to claim 11, all the limitations of which are incorporated herein by reference, further comprising a controller connected to said dispenser and said ultraviolet light source, wherein said controller is adapted to provide said etching ambient environment and said ultraviolet radiation simultaneously.

13. The apparatus according to claim 11, all the limitations of which are incorporated herein by reference, further comprising a controller connected to said dispenser and said ultraviolet light source, wherein said controller is adapted to provide said etching ambient environment before said ultraviolet radiation.

14. The apparatus according to claim 11, all the limitations of which are incorporated herein by reference, wherein said dispenser is adapted to provide said etching ambient environment in such concentrations that said etching ambient environment removes hydrogen from said deposited thin film.

15. The apparatus according to claim 11, all the limitations of which are incorporated herein by reference, wherein said dispenser is adapted to provide said etching ambient environment in such concentrations that said etching ambient environment removes oxygen from said deposited thin film.

16. An apparatus comprising:
a chamber adapted to accommodate a substrate comprising a deposited thin film;
a dispenser connected to said chamber, wherein said dispenser is adapted to create, within said chamber, an etching ambient environment;
a generator connected to said chamber, wherein said generator is adapted to generate an electrical discharge in said chamber; and
an ultraviolet light source within said chamber adapted to irradiate said substrate with ultraviolet radiation.

17. The apparatus according to claim 16, all the limitations of which are incorporated herein by reference, further comprising a controller connected to said dispenser, said generator, and said ultraviolet light source, wherein said controller is adapted to provide said etching ambient environment, said electrical discharge, and said ultraviolet radiation simultaneously.

18. The apparatus according to claim 16, all the limitations of which are incorporated herein by reference, further comprising a controller connected to said dispenser, said generator, and said ultraviolet light source, wherein said controller is adapted to provide said etching ambient environment and said electrical discharge before said ultraviolet radiation.

19. The apparatus according to claim 16, all the limitations of which are incorporated herein by reference, wherein said dispenser is adapted to provide said etching ambient environment in such concentrations, and said generator is adapted to generate said electrical discharge in such a manner that said etching ambient environment removes hydrogen from said deposited thin film.

20. The apparatus according to claim 16, all the limitations of which are incorporated herein by reference, wherein said dispenser is adapted to provide said etching ambient environment in such concentrations, and said generator is adapted to generate said electrical discharge in such a manner that said etching ambient environment removes oxygen from said deposited thin film.
